(19) United States
(12) Patent Application Publication
(10) Pub. No.: US 2017/0087669 A1
(43) Pub. Date: Mar. 30, 2017

(54) APPARATUS AND METHOD FOR PRODUCING AND/OR REPAIRING IN PARTICULAR ROTATIONALLY SYMMETRICAL COMPONENTS

(71) Applicant: MTU Aero Engines AG, Munich (DE)

(72) Inventors: Martin SCHLOFFER, Munich (DE); Karl-Hermann RICHTER, Markt Indersdorf (DE)

(21) Appl. No.: 15/272,514

(22) Filed: Sep. 22, 2016

(30) Foreign Application Priority Data
Sep. 25, 2015 (DE) 102015218477.3
Nov. 24, 2015 (DE) 102015223189.5

(51) Int. Cl. B23K 26/342; B23K 15/00

(52) U.S. Cl. CPC B23K 26/342; B23K 15/0006; B23K 2203/14

(57) ABSTRACT

An apparatus and a method for producing and/or repairing a component. The method comprises:
a. providing a component and/or a starting platform,
b. placing the component and/or the starting platform on a sample table,
c. preheating the component and/or the starting platform by a heating source to a temperature from about 300° C. below to about 50° C. above the brittle-ductile transition temperature of the material of the component,
d. applying a wire-shaped and/or rod-shaped filler material comprising TiAl to the component and/or starting platform by build-up welding, an energy source melting the filler material.

### CROSS-REFERENCE TO RELATED APPLICATIONS

The present application claims priority under 35 U.S.C. §119 of German Patent Application No. 102015218477.3, filed Sep. 25, 2015, and German Patent Application No. 102015223189.5, filed Nov. 24, 2015. The entire disclosures of the priority applications are expressly incorporated by reference herein.

### BACKGROUND OF THE INVENTION

1. Field of the Invention

The invention relates to a method for producing and/or repairing in particular rotationally symmetrical components. The invention further relates to a corresponding apparatus according for carrying out the method.

2. Discussion of Background Information

It is known to cast or to forge components from titanium aluminide (γ-TiAl). However, the components are becoming ever more complex and larger, with the wall thicknesses of the components becoming ever smaller for weight reasons. If TiAl components of this nature are required in very small quantities, conventional production will be uneconomical or is no longer possible on account of the increasing complexity.

Thus, generative production by means of powder presents itself. In virtual terms, the component to be produced is split into a plurality of mutually parallel layers. In this case, a laser is used to sinter or melt the metal powder onto those sites which correspond to the current component layer of the virtual model. The component located on a platform is lowered slightly. Fresh metal powder is applied to the surface. Then, the next layer is heated in accordance with the virtual data. This is repeated until all the layers have been produced.

In the case of such methods based on a powder bed, however, there is a serious risk of the formation of pores, impurities and bonding errors.

In view of the foregoing, it would be advantageous to have available a method and a corresponding apparatus which make the cost-effective production of TiAl components in small quantities possible.

### SUMMARY OF THE INVENTION

The present invention provides a method for producing and/or repairing in particular rotationally symmetrical components. The method comprises:
(a) providing a component and/or a starting platform,
(b) placing the component and/or the starting platform on a sample table,
(c) preheating the component and/or the starting platform to a specific temperature by a heating source,
(d) applying a wire-shaped and/or rod-shaped filler additive material comprising Tim to the component and/or starting platform by build-up welding, an energy source melting the filler additive material.

The specific temperature in (c), which will usually be in the range from about 500° C. to about 850° C., ranges from about 300° C. below to about 50° C. above the brittle-ductile transition temperature of the material of the component.

In one aspect of the method, (c) and/or (d) may be carried out in vacuo, in particular at a pressure of less than about 10⁻³ mbar.

In another aspect, the preheating in (c) may be carried out with at least one of a radiation furnace, a laser, and an electron source.

In yet another aspect of the method, in (c) the heating power may be from about 400 W to about 1200 W.

In a still further aspect of the method, in (d) the energy source may be a laser and/or an electron source.

In another aspect, the diameter of the wire-shaped and/or rod-shaped filler additive material may be from 0.3 mm to 2 mm.

In another aspect, in (c) and/or in (d) the component and/or the starting platform may be turned, in particular continuously.

The present invention also provides a component which has been produced by the method set forth above (including the various aspects thereof).

In one aspect of the component, the component may be made of titanium aluminide and/or the component may be a guide ring, a housing part in a compressor and/or turbine, an outlet guide wheel, a stator segment and/or a sealing ring.

The present invention also provides an apparatus for producing and/or repairing in particular rotationally symmetrical components. The apparatus comprises:
a process chamber,
a sample table movable in particular in rotation and/or translation,
an annular heating source made up of a plurality of individual segments and arranged around a heating region which is arranged over the sample table, and
a sample head having at least one energy source for melting a filler additive material and comprising at least one feed unit for the filler additive material.

In one aspect, the apparatus may further comprise a storage vessel and/or a conveying unit for a filler additive material, which is or are arranged in the process chamber.

In another aspect of the apparatus, the heating source may comprise at least one of a laser, an electron source, a radiation furnace.

In yet another aspect, an individual segment of the heating source may comprise at least one luminaire and/or at least one, in particular water-cooled, metal block. For example, the luminaire may be arranged in the, in particular mirrored, metal block and/or the spacing between the luminaire and the component and/or starting platform may be from 1 cm to 30 cm.

In a still further aspect of the apparatus, the energy source may comprise a laser and/or an electron source.

As set forth above, the invention relates to a method for producing and/or repairing in particular rotationally symmetrical components. The method comprises the following steps. In step (a), a component and/or a starting platform are provided. This starting platform can be produced from a high-temperature-resistant alloy. These include, for example, Ni-based, Co-based, Fe-based and/or Mo-based alloys. In step (b), the component or the starting platform is placed on a sample table. Then, in step (c), the component or the starting platform is preheated to a specific temperature by means of a heating source. Then, in step (d), a wire-shaped or rod-shaped filler additive material comprising TiAl is applied to the component or to the starting platform by means of build-up welding. In this case, the TiAl of the filler additive material can have a composition which takes into account, or even partially or entirely prevents, the evaporation of aluminum from the filler additive material during step (d). In this case, an energy source causes the filler additive material to melt. According to the present invention, the specific temperature during preheating in step (c) lies in the range from about 300° C. below to about 50° C. above the brittle-ductile transition temperature of the component material. In particular, the temperature can lie in the range from about 500° C. to about 850° C. This method has the advantage that the production times are low and a high yield of material is achieved. Furthermore, the production can be effected near net shape. Even very complex shapes are now possible in this way.

In one advantageous configuration of the invention, step (c) and/or step (d) is carried out in vacuo, in particular at a pressure of less than about 10⁻³ mbar. The vacuum affords the advantage that there are very low heat losses via the heat conduction.

In a further advantageous configuration of the invention, the preheating in step (c) takes place by means of a radiation furnace, a laser and/or an electron source. The heating power is preferably in the range from about 400 W to about 1200 W. This has the advantage that even complex and large components can be preheated uniformly.

In a further advantageous configuration of the invention, in step (d) the energy source used is at least one laser and/or at least one electron source. These energy sources can advantageously be redirected very quickly in all spatial directions. By using the electron beam, it is possible to achieve higher deposition rates than when a laser beam is used, since more energy can be introduced per unit of time and the deflection is quicker (electrical coils) than in the case of the laser (mechanical lenses). The economic viability of the electron beam method is increased as a result. By contrast, the laser is less susceptible to interference by an electrical field from a radiation furnace. If it is not possible to compensate for the diversion of the electron beam as energy source by the interfering fields of the radiation furnace, it is possible to preheat the entire component only by means of the electron beam as heating source. It is also conceivable to heat the entire component only by means of a laser as heating source, but this would be realized via a separate second laser or a plurality of further lasers. In addition, the temperature can be controlled and/or regulated by way of a temperature sensor, such as a pyrometer and/or thermocouple.

In a further advantageous configuration of the invention, the diameter of the wire-shaped and/or rod-shaped filler metal is from 0.3 mm to 2 mm. This allows for a continuous feed, and therefore the microstructure of the filler additive material is reproducible after the melting.

In a further advantageous configuration of the invention, in step (c) and/or in step (d) the component and/or the starting platform is turned, in particular continuously. This has the advantage that in particular large rotationally symmetrical components can also be preheated uniformly in vacuo in the construction sector, such that no microcracks form during the wire build-up welding of TiAl material.

In a further advantageous configuration of the invention, the component is a guide ring, a housing part in the compressor and/or turbine, an outlet guide wheel, a stator segment and/or a sealing ring. Components of this type are particularly large and rotationally symmetrical. It is often the case that components of this type have small and different wall thicknesses, such that induction heating, for example, causes scarcely any induction current or induction current of a differing level to flow in the component wall. These components can be produced from TiAl.

The invention further relates to an apparatus for producing and/or repairing in particular rotationally symmetrical components. The apparatus comprises a process chamber, a sample table movable in rotation and/or translation, an annular heating source, which is arranged around a heating region arranged over the sample table, and a sample head having at least one energy source for melting a filler additive material and having a feed unit for the in particular wire-shaped or rod-shaped filler additive material, which preferably comprises TiAl. The feed unit can thus be a wire nozzle.

In this case, the heating source is preferably made up of a plurality of individual segments. By way of example, at least two individual segments can be arranged alongside one another. This affords the advantage that the number of individual segments can be adapted to the diameter of the component. It is thereby possible to ensure that the heating source can be arranged sufficiently close to the component to be produced or to the component to be repaired. In particular, the spacing between the component and the heating source should be in the range from 1 cm to 30 cm. The process chamber can preferably have a strong rotary vacuum pump water-cooled at the flange on the housing wall of the process chamber. Gas which has been sucked up from the operation of pre-cleaning and flushing with noble gas (Ar, He) can be purified and reused.

In a further advantageous configuration of the invention, the apparatus comprises a storage vessel and/or a conveying unit for a filler additive material, which is or are arranged in the process chamber. Thus, the storage vessel can be a roller with coiled TiAl wire, for example. The conveying unit can be a drive roller, which can feed the wire. The filler additive material can be stored in the apparatus in vacuo, as wire material on a roller and as rod material in a cylindrical rod feed conveyor. Material can be refilled via a separate lock. The rods can be guided to the sample head without welding, edge-to-edge, or as welded-together wire.

In a further advantageous configuration of the invention, the heating source comprises a laser, an electron source and/or a radiation furnace.

In a further advantageous configuration of the invention, the individual segment comprises at least one luminaire and/or at least one, in particular water-cooled, metal block. The luminaire is preferably arranged in the, in particular mirrored, metal block. This has the advantage that the heat radiation of the at least one luminaire can be exploited better. Furthermore, the heat generated by the luminaire can be transported away better owing to the thermal conductivity of the metal block.

In a further advantageous configuration of the invention, the energy source comprises a laser and/or an electron source. On the one hand, higher deposition rates can be produced with an electron source than with a laser. However, the electron beams are more susceptible than laser beams to electrical interference fields, for example from a radiant heating system.

Further advantageous configurations of the invention are specified in the dependent claims.

### BRIEF DESCRIPTION OF THE DRAWINGS

Hereinbelow, preferred exemplary embodiments of the invention will be described in more detail on the basis of the schematic drawings, in which:

FIG. 1: shows a plan view of the apparatus according to the invention,

FIG. 2: shows a side view of the apparatus according to the invention, and

FIG. 3: shows the individual method steps for producing or repairing a component.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

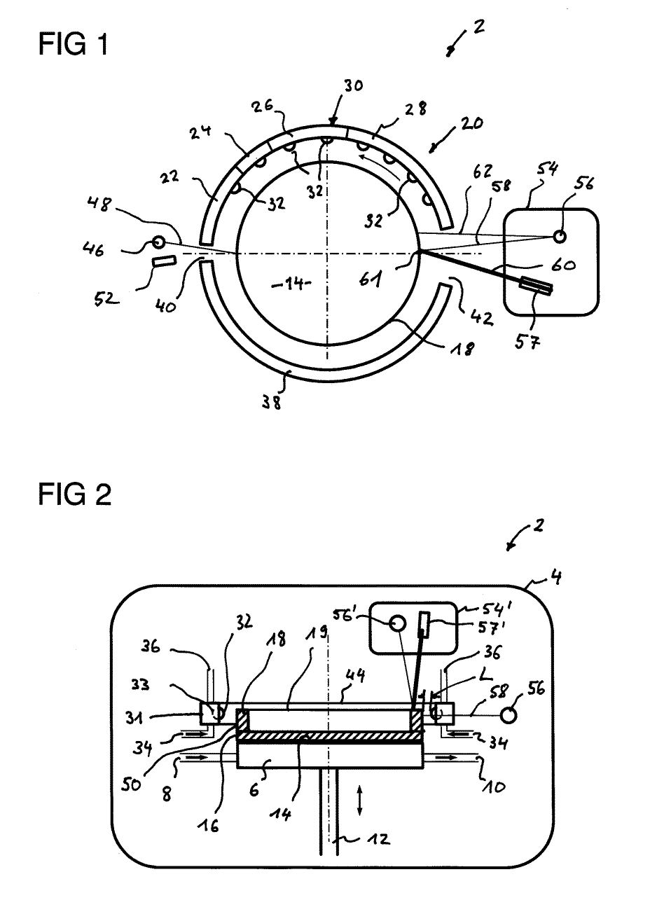

FIG. 1 shows a plan view of an embodiment of the apparatus 2 according to the invention and FIG. 2 shows a side view of an embodiment of the apparatus 2 according to the invention, having a process chamber 4 which can be set in vacuo. The apparatus 2 comprises a sample table 6, which can have a water feed 8 and a water discharge 10. This achieves water cooling of the sample table 6. A vertically adjustable punch 12 is arranged beneath the sample table 6. A preferably likewise water-cooled starting platform 14 is arranged on the, in this case circular, sample table 6. This starting platform 14 is thermally insulated downward toward the sample table 6 in order to thermally decouple the sample table 6. The starting platform 14 can be produced from a high-temperature-resistant alloy. These include, for example, Ni-based, Co-based, Fe-based and Mo-based alloys. The starting platform 14 can have supporting structures. An annular component 18 comprising titanium aluminide is constructed partially on the, in this case circular, starting platform 14 over the circumference 16 thereof. A heating source 20 is arranged around the component 18.

In the upper region of FIG. 1, the heating source 20 has four individual segments 22, 24, 26 and 28 separated from one another here. The individual segments 22, 24, 26 and 28 adjoin one another and form a first partial ring 30 of the heating source 20. Each individual segment has at least one metal block 31 and a luminaire 32. The metal block 31 has at least one receptacle 33 for a luminaire 32. Furthermore, the metal block 31 can have a water feed 34 and water discharge 36 for the water cooling. The receptacle 33 is preferably mirrored. It is also possible for the entire metal block 31 to be mirrored. It can be gathered from FIG. 1 that, for example, the first and second individual segments 22 and 24 merely each have one luminaire 32. By contrast, the third individual segment 26 has two luminaires 32. By contrast, the fourth individual segment 28 has four luminaires. In the lower region of FIG. 1, the heating source 20 has a second partial ring 38, which has a similar construction to the first partial ring 30.

The two partial rings 30 and 38 leave a first gap 40 and a second gap 42 free on the left and on the right in FIG. 1. The two partial rings 30 and 38 (there may also be more than two partial rings if more than two gaps are required) are arranged at a substantially equidistant spacing L from the component 18. As can be gathered from FIG. 2, the topmost edge 19 of the component 18 is arranged below the topmost edge 44 of the partial ring 30. It is thereby possible to ensure that the layer which is to be applied to the topmost edge 19 of the component 18 impacts on a temperature-controlled surface at a temperature of from about 500° C. to about 850° C., such that no microcracks can form.

A laser 46, shown on the left in FIG. 1, for reheating or heating the component 18 is arranged here outside the heating source 20, level with the first gap 40. The laser beam 48 of the laser 46 in this respect impinges on the circumferential surface 50 of the component 18. A temperature sensor 52 is arranged alongside said laser and measures the surface temperature on the circumferential surface 50.

A sample head 54, shown on the right in FIG. 1, is arranged outside the heating source 20, level with the second gap 42. The sample head 54 comprises an energy source 56, here an electron source, and a feed unit 57 for a filler metal formed from TiAl. Said filler metal is rod-shaped or wire-shaped. Here, the electron source 56 produces a first electron beam 58, which impinges on the circumferential surface 50 of the component 18. The tip of the wire 60 from the feed unit 57 is positioned at this point 61. At the weld point 61, new material is applied to the already present component 18 by melting the wire 60. In the process, the sample table 6 turns counterclockwise here (see FIG. 1). The component 18 grows in terms of height in the manner of a helix or spiral.

In combination therewith or as an alternative thereto, a further sample head 54′ having an energy source 56′ and a feed unit 57′ can be arranged above the component (see FIG. 2). In an alternative case, no gaps 40 and 42 are required, and therefore the heating source 20 can form a closed ring. The heating source 20 can adapt to the contour of the component 18 by means of the individual segments. In combination therewith or as an alternative thereto, the sample table 6 can be fixed and the sample head 54′ can be moved according to the 3D data of the layer presently to be built up.

The electron source 56 affords the possibility to split the beam thereof into a plurality of beams, such that, as is visible in FIG. 1, a second electron beam 62 is produced by the electron source 56. This second electron beam 62 can reheat the melt trace and structure which has just been melted in a controlled manner, such that a reproducible cooling rate can be set.

The heating source 20, formed as a radiation furnace, ensures that there is a uniform temperature of the entire component 18 located in the heating region. In this respect, this heating source 20 shown in FIG. 1 and FIG. 2 manages readily with different wall thicknesses.

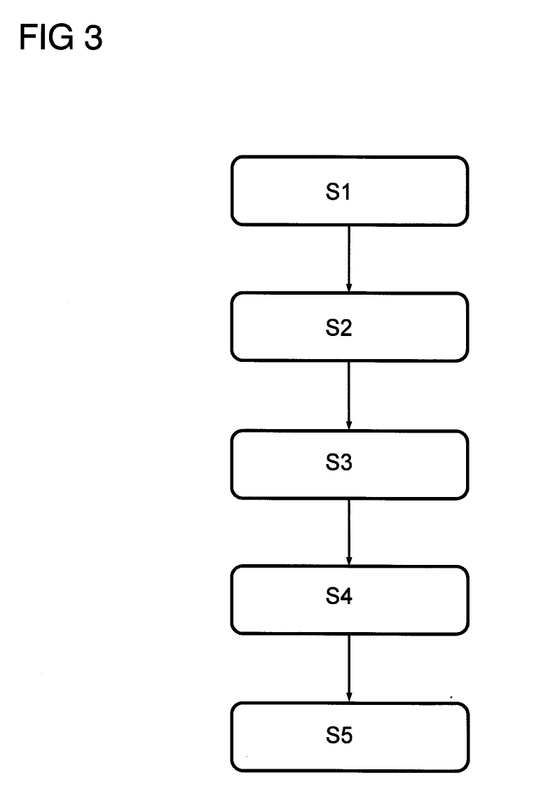

FIG. 3 shows the individual method steps of a first embodiment. All of the necessary elements, as are shown in FIG. 1 and FIG. 2, are arranged in the process chamber 4.

Firstly, in step S1, the process chamber 4 is cleaned. In this process, the process chamber 4 is evacuated down to a negative pressure of about 10⁻⁵ mbar. Then, the process chamber 4 is flooded with an inert gas (Ar and/or He). The process chamber is evacuated again after the flooding. The flushing can be repeated a number of times here as required.

In step S2, the starting platform 16 or the component 18 to be repaired is then preheated to a temperature of about 500° C. to about 850° C. by means of the heating source 20 in the form of a radiation furnace, and the sample table 6 is turned. At the same time, the wire 60 and the first electron beam 58 impinge on the weld point 61.

In step S3, the component is slowly cooled after the end of the construction job.

Then, in step S4, any supporting structures present are removed.

Finally, in step S5, the component 18 is mechanically reworked. Here, the necessary contact surfaces of the component 18 shown here are machined, for example by grinding or milling, in order to obtain planar surfaces. Further surfaces of the component at which high stresses arise are likewise mechanically reworked.

It is thereby possible to produce large, approximately rotationally symmetrical components made of TiAl for aero engine applications at from room temperature to about 900° C. It is thereby possible to cost-effectively produce a few large, complex parts per aero engine in low quantities.

By means of electron beam build-up welding, it is thereby possible to use an additive production method which makes it possible to achieve relatively short construction times, a high material yield, near-net-shape and complex shaping and therefore components and structures which to date have not been able to be produced from TiAl.

Although the present invention has been described in detail with the aid of the exemplary embodiments, it is clear to the person skilled in the art that the invention is not restricted to these exemplary embodiments, but rather that variants are possible in that individual features may be omitted or other combinations of features may be implemented, so long as the protective scope of the appended claims is not departed from. The present disclosure also includes all combinations of the individual features proposed.

### LIST OF REFERENCE NUMBERS

2 Apparatus
4 Process chamber
6 Sample table
8 Water feed of 6
10 Water discharge of 6
12 Punch
14 Starting platform
16 Circumference of 14
18 Component
19 Edge of 18
20 Heating source
22 Individual segment
24 Individual segment
26 Individual segment
28 Individual segment
30 First partial ring
31 Metal block
32 Luminaire
33 Receptacle
34 Water feed of 31
36 Water discharge of 31
38 Second partial ring
40 First gap
42 Second gap
44 Topmost edge of 30
46 Laser
48 Laser beam
50 Circumferential surface of 18
52 Temperature sensor
54 Sample head
56 Electron source
57 Feed unit
58 First electron beam
60 Wire
61 Weld point

What is claimed is:

1. A method for producing and/or repairing a component, wherein the method comprises:
(a) providing a component and/or a starting platform,
(b) placing the component and/or the starting platform on a sample table,
(c) preheating the component and/or the starting platform to a specific temperature by a heating source,
(d) applying a wire-shaped and/or rod-shaped filler additive material comprising TiAl to the component and/or starting platform by build-up welding, an energy source melting the filler additive material,
and wherein, in (c), the specific temperature ranges from about 300° C. below to about 50° C. above a brittle-ductile transition temperature of a material of the component.

2. The method of claim 1, wherein (c) and/or (d) is carried out in vacuo.

3. The method of claim 1, wherein (c) and/or (d) is carried out at a pressure of less than about 10⁻³ mbar.

4. The method of claim 1, wherein the preheating in (c) is carried out with at least one of a radiation furnace, a laser, an electron source.

5. The method of claim 1, wherein in (c) the heating power is from about 400 W to about 1200 W.

6. The method of claim 1, wherein in (d) the energy source is a laser and/or an electron source.

7. The method of claim 1, wherein a diameter of the wire-shaped and/or rod-shaped filler additive material is from 0.3 mm to 2 mm.

8. The method of claim 1, wherein in (c) and/or in (d) the component and/or the starting platform is turned.

9. A component which is produced by the method of claim 1.

10. The component of claim 9, wherein the component is made of titanium aluminide.

11. The component of claim 9, wherein the component is a guide ring, a housing part in a compressor and/or turbine, an outlet guide wheel, a stator segment and/or a sealing ring.

12. An apparatus for producing and/or repairing a component, wherein the apparatus comprises:
a process chamber,
a movable sample table,
an annular heating source made up of a plurality of individual segments and arranged around a heating region which is arranged over the sample table, and
a sample head having at least one energy source for melting a filler additive material and comprising at least one feed unit for the filler additive material.

13. The apparatus of claim 12, wherein the apparatus further comprises a storage vessel and/or a conveying unit for a filler additive material, which is or are arranged in the process chamber.

14. The apparatus of claim 12, wherein the heating source comprises at least one of a laser, an electron source, a radiation furnace.

15. The apparatus of claim 12, wherein an individual segment comprises at least one luminaire and/or at least one metal block.

16. The apparatus of claim 15, wherein the metal block is cooled with water.

17. The apparatus of claim 15, wherein the luminaire is arranged in the metal block.

18. The apparatus of claim 17, wherein the metal block is mirrored.

19. The apparatus of claim 15, wherein a spacing between the luminaire and the component and/or starting platform (14) is from 1 cm to 30 cm.

20. The apparatus of claim 12, wherein the energy source comprises a laser and/or an electron source.
